(19) United States
(12) Patent Application Publication
(10) Pub. No.: US 2016/0352578 A1
(43) Pub. Date: Dec. 1, 2016

(54) SYSTEM AND METHOD FOR ADAPTIVE PATHS LOCATOR FOR VIRTUAL NETWORK FUNCTION LINKS

(71) Applicant: DELL PRODUCTS L.P., Round Rock, TX (US)

(72) Inventors: YuLing Chen, Fremont, CA (US); Yinghua Qin, Zhuhai (CN)

(73) Assignee: DELL PRODUCTS L.P., Round Rock, TX (US)

(21) Appl. No.: 14/722,125

(22) Filed: May 26, 2015

(51) Int. Cl. H04L 12/24

(52) U.S. Cl. CPC H04L 41/12; H04L 41/04; H04L 41/20

(57) ABSTRACT

The present invention relates generally to data communication networks and devices, and relates more particularly to monitoring and management in network functions virtualization networks (NFV) where a plurality of virtualize network functions (VNF) are chained together. Aspects of the present invention include monitoring and management across multiple virtual and physical paths. In embodiments of the present invention a software defined networking (SDN) controller can be implemented, but does not have to be implemented.

### BACKGROUND

### Field of Invention

The present invention relates generally to data communication networks and devices, and relates more particularly to monitoring and management in network functions virtualization networks (NFV) where a plurality of virtualize network functions (VNF) are chained together.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems provide increasingly more central and critical operations in modern society, it is important that the networks are reliable. One way to improve reliability is through monitoring and management of storage in networking systems.

Network Functions Virtualization (NFV) is a network architecture that uses Information Technology (IT) virtualization technologies to virtualize entire classes of network node functions into building blocks that can be connected, or chained, together to create communication services.

A service provider following the NFV design can implement one or more Virtualized Network Functions (VNFs) where multiple VNFs can be used in sequence to form a service chain to deliver a network service. Such a service chain can also contain one or multiple Physical Network Functions (PNFs) working in conjunction with the VNFs to provide end-to-end network services, which are usually referred to as virtual and physical function co-existence scenarios.

Service chaining scenarios in NFV is also referred to as VNF Forwarding Graphs. VNFs can be connected together in a ‘graph’ instead of a sequential ‘chain’ hence the VNF Forwarding Graph term can be used. For ease of explanation the following specification will use the terms service chaining and VNF Forwarding Graph interchangeably.

The network services provided by service chaining can run on redundant underlying virtual and physical network infrastructures. Network redundancy provides alternative paths for data to travel along in case a Virtual Machine (VM) is down, a network device is broken, or a connector accidentally un-plugged. Of course, there can be redundancy support on the network service level achieved by adding redundant VNFs or VNF level redundant paths for the robustness of the network service.

Furthermore, the network services with service chaining can run on network environment with or without Software Defined Networking (SDN). In a network environment without SDN, the physical network forwarding paths are configured statically. In a network environment with SDN, the physical network paths can be configured dynamically though the control plane resides centrally in the SDN controller.

From the architecture point of view, NFV systems contain three layers: Network Service Layer (NSL), Virtualized Infrastructure Layer (VIL), and Physical Network Layer (PNL). The VNF Forwarding Graph on Network Service Layer relies on the virtual resources including the VMs and network connectivity between the VMs on the virtualized infrastructure layer, which in turn relies on the physical resources including the computer, storage, and physical network connectivity provided on physical layer. Therefore, the network services in the upper layer have dependency on the virtualized infrastructure layer as well as the physical infrastructure layer.

All the complexity in NFV environment creates new opportunities, requirements and challenges in many perspectives of telecom industry. One challenge is the health monitoring of the network services with underlying redundant network topologies in service chaining scenarios. The monitoring of the network services with service chaining consists of the monitoring of the VNFs as well as the VNF Links. VNF links are the logical links on network service level that connects two adjacent VNFs together in a VNF Forwarding Graph. In virtual and physical co-existence scenarios, the links from the VNFs to the physical network functions (PNFs) or the links from the PNFs to VNFs also need to be monitored. This is called VNF_To_PNF_Links or PNF_To_VNF_Links, respectively.

Since VNFs contain both the virtual instances and the virtual links between them, the monitoring of the VNFs boils down to the monitoring of the virtual instances (VMs if the virtual container is virtual machines) and the virtual links between the VMs. The monitoring of the VNF Links, VNF_TO_PNF_Links, and PNF_To_VNF_Links boils down to the monitoring of the links between VMs and the links between VMs and the physical equipment. The monitoring of the VMs is relatively straight forward. There are tools in the related industry that provide the capability of monitoring the health of the VMs in the cloud. However, the monitoring of the links between the VMs or the links between the VMs and the physical equipment is complex and challenging. The health status of these links depends on both virtual and physical network connectivity provided from virtualized infrastructure and physical network layers respectively.

Accordingly, what is needed is to monitor the health of network service in service chaining embodiment with redundant underlying network topology. One important step to monitoring the health of the network service chaining embodiment includes monitoring the health status of the virtual links between VMs and the links between the VMs and the physical equipment.

Accordingly, what is needed is a system and method that can monitor across virtual and physical network paths associated with a VNF link in a VNF service changing embodiment.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the spirit and scope of the invention to these particular embodiments. These drawings shall in no way limit any changes in form and detail that may be made to the invention by one skilled in the art without departing from the spirit and scope of the invention.

FIG. 1 depicts an example of a service chaining embodiment according to embodiments of the present invention.

FIG. 2 depicts a block diagram of an embodiment of an NFV monitoring system including a path locator according to embodiments of the present invention.

FIG. 3 depicts a flowchart showing the process flow to locate the network paths for two endpoints in NFV systems according to embodiments of the present invention.

FIG. 4 depicts a block diagram of an NFV architecture system according to embodiments of the present invention.

FIG. 5 depicts a block diagram of an NFV monitoring system according to embodiments of the present invention.

### DESCRIPTION OF THE PREFERRED EMBODIMENTS

In the following description, for purposes of explanation, specific examples and details are set forth in order to provide an understanding of the invention. It will be apparent, however, to one skilled in the art that the invention may be practiced without these details. Well known process steps may not be described in detail in order to avoid unnecessarily obscuring the present invention. Other applications are possible, such that the following examples should not be taken as limiting. Furthermore, one skilled in the art will recognize that aspects of the present invention, described herein, may be implemented in a variety of ways, including software, hardware, firmware, or combinations thereof.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules.

Furthermore, connections between components within the figures are not intended to be limited to direct connections. Rather, data between these components may be modified, re-formatted, or otherwise changed by intermediary components (which may or may not be shown in the figure). Also, additional or fewer connections may be used. It shall also be noted that the terms “coupled” or “communicatively coupled” shall be understood to include direct connections, indirect connections through one or more intermediary devices, and wireless connections.

In the detailed description provided herein, references are made to the accompanying figures, which form a part of the description and in which are shown, by way of illustration, specific embodiments of the present invention. Although these embodiments are described in sufficient detail to enable one skilled in the art to practice the invention, it shall be understood that these examples are not limiting, such that other embodiments may be used, and changes may be made without departing from the spirit and scope of the invention.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, such phrases in various places in the specification are not necessarily all referring to the same embodiment or embodiments. It shall be noted that the use of the terms “set” and “group” in this patent document shall include any number of elements. Furthermore, it shall be noted that methods or algorithms steps may not be limited to the specific order set forth herein; rather, one skilled in the art shall recognize, in some embodiments, that more or fewer steps may be performed, that certain steps may optionally be performed, and that steps may be performed in different orders, including being done some steps being done concurrently.

The present invention relates in various embodiments to devices, systems, methods, and instructions stored on one or more non-transitory computer-readable media involving the communication of data over networks. Such devices, systems, methods, and instructions stored on one or more non-transitory computer-readable media can result in, among other advantages, the ability to monitor the health status of VNF network devices and paths in an NFV architecture.

It shall also be noted that although embodiments described herein may be within the context of management in a network device, the invention elements of the current patent document are not so limited. Accordingly, the invention elements may be applied or adapted for use in other contexts.

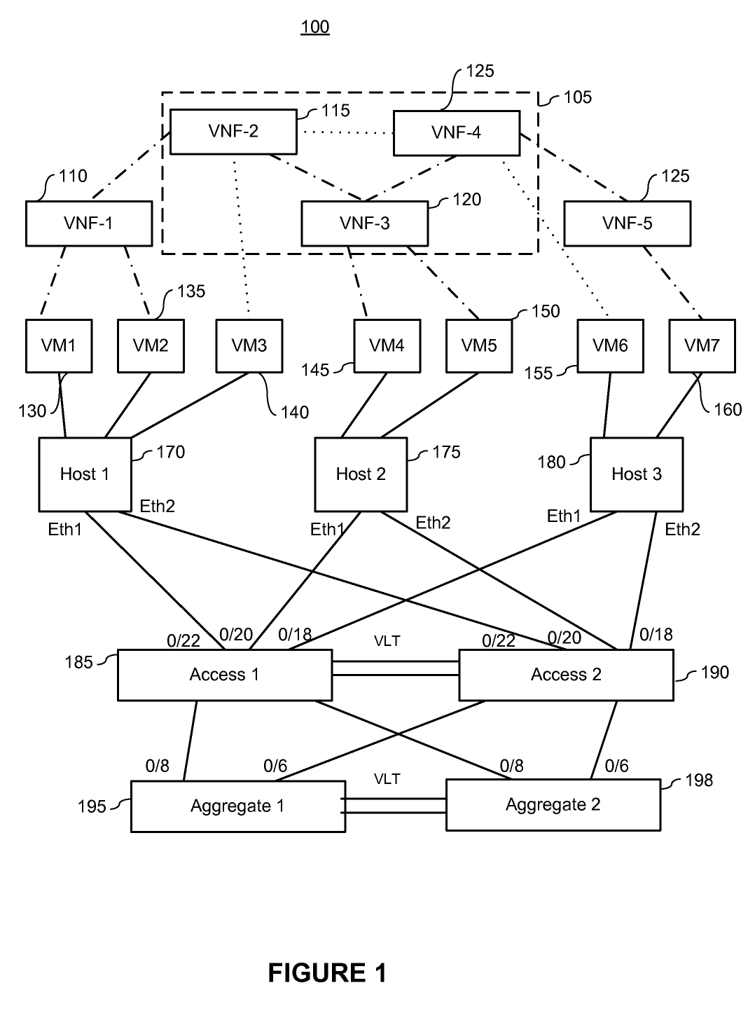

FIG. 1 shows an embodiment of a service chaining system where a set of VNFs connect together to provide a network service. FIG. 1 shows VNFs VNF-1 110, VNF-2 115, VNF-3 120, VNF-4 125, and VNF-5 130. Each VNF contains a plurality of VNFCs (not shown). Each VNFC maps to a particular Virtual Machine (VM). FIG. 1 also shows a virtual infrastructure layer, a plurality of VMs VM1 130, VM2 135, VM3 140, VM4 145, VM5 150, VM6 155, VM7 160. FIG. 1 also shows physical layer with host 1 170, host 2 175, and host 3 180. FIG. 1 also shows access 1 185 and access 2 190 and aggregate 1 195 and aggregate 2 198.

As shown in FIG. 1, the connectivity of the link between VNF-2 115 and VNF-4 125 has dependency on the connectivity of multiple paths in the underlying virtualization layer and physical network layer. As shown in FIG. 1, a VNF link on the Network Service Layer maps to Virtual Links on Virtual Infrastructure Layer, and then to the Physical Network Paths on Physical Network Layer. The dotted lines shown in FIG. 1 between VNFs illustrate VNF links. The dashed line around VNF-2 115, VNF-3 120, and VNF-4 125 represents a grouping of VNFs 105.

In many cases, there exist multiple paths (some paths are represented in FIG. 1 by dashed and solid lines) in the physical network to provide the redundancy support so that when one path has connectivity issues, another path could take over. Therefore, only when all the physical paths associated with the virtual link go down, will the virtual link goes down.

FIG. 1 shows an embodiment where VNF links are dependent on multiple physical paths in physical network layer. The embodiments of VNF links being dependent on multiple paths on both virtual and physical infrastructures can be similar. In those embodiments, multiple VMs can be associated with one VNF to contribute to multiple paths in virtual and physical layers. In virtual and physical co-existence embodiments, VNF_To_PNF_Links and PNF_To_VNF_Links can also depend on multiple paths in virtual and physical layers.

From the monitoring point of view, if the monitoring tool can report the health status of VNFs, VNF links, VNF_To_PNF_Links, and PNF_To_VNF_Links, then the health status of network could be determined

Since VNFs contain both the virtual instances and the virtual links between them, the monitoring of the VNFs boils down to the monitoring of the virtual instances (VMs if the virtual container is virtual machines) and the virtual links between the VMs. The monitoring of the VNF Links, VNF_TO_PNF_Links, and PNF_To_VNF_Links boil down to the monitoring of the links between VMs and the links between VMs and the physical equipment. The monitoring of the VMs is relatively straight forward. There are tools in the related industry that provide the capability of monitoring the health of the VMs in the cloud. However, the monitoring of the links between the VMs or the links between the VMs and the physical equipment is complex and challenging. The health status of these links depends on both virtual and physical network connectivity provided from virtualized infrastructure and physical network layers respectively.

How to report the health status of a VNF link, VNF_To_PNF_Link, or PNF_to_VNF_Link based on the monitoring of multiple layers in NFV system becomes a problem in the NFV area, particularly when the system does not have the capability of discovering the physical topology with detailed path information.

What is needed is a path locator tool to understand the ‘Path’ concept and multiple Paths associated with two endpoints in the physical network system.

Embodiments of the present invention provide a VNF Link Paths Locator that reports the underlying network ‘Paths’ for a link on a VNF level. These embodiments can be used where NFV monitoring systems have the capability of monitoring the health status of various entities including both physical and virtual, such as switches, switch ports, hosts, physical network interface controllers (NICs) on the hosts, VMs, virtual NICs, etc. However, the NFV monitoring tool does not have the capability of discovering the physical links nor paths between two physical endpoints in a complex physical topology of the network.

Advantages of embodiments of the present invention is that it provides a component that is called VNF link paths locator, which has the capability of locating the virtual and physical paths associated with links between two VNFs or a VNF and a physical network endpoint in virtual and physical network function co-existence embodiments.

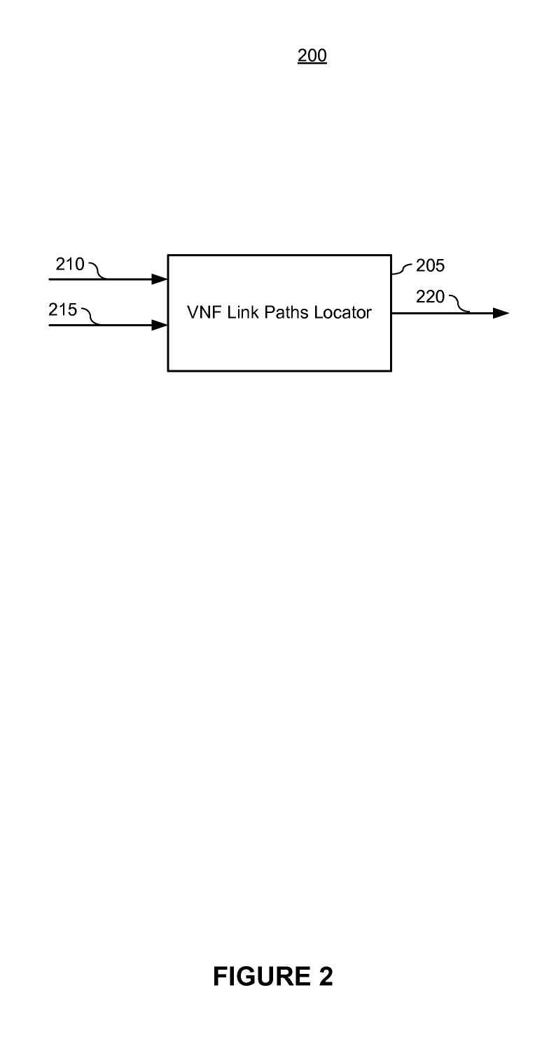

FIG. 2 illustrates the inputs and output of the VNF link path locator. FIG. 2 shows two inputs 210 and 215 going into VNF paths locator 205 and one output 220. The VNF link paths locator takes a pair of endpoints which could be a pair of VNFs associated with a VNF link or a VNF and a physical network endpoint associated with VNF_To_PNF_Link or PNF_To_VNF_Link as input 210 and 215. The VNF link paths locator 205 will reply with the result of one or multiple paths between the two endpoints in a regular expression format 220.

Using the example show in FIG. 1, the link between VNF-2 115 and VNF-4 125 contains the following paths:

Path1: (VM3 140, VNIC3)→(Host1 170, eth1)→(Access1 185, 0/22)→(Aggregate1 195, 0/8)→(Aggregate1 195, 0/6)→(Access2 190, 0/18)→(Host3 180, eth2))→(VM6 155, VNIC6)

Path2: (VM3 140, VNIC3)→(Host1 170, eth1)→(Access1 185, 0/22)→(Aggregate2 198, 0/6)→(Aggregate2 198, 0/6)→(Access2 190, 0/18)→(Host3 180, eth2)→(VM6 155, VNIC6)

Path3: (VM3 140, VNIC3)→(Host1 170, eth1)→(Access1 185, 0/22)(Access1 185, 0/18)→(Host3 180, eth1)→(VM6 155, VNIC6)

Path4: (VM3 140, VNIC3)→(Host1 170, eth2)→(Access2 190, 0/22)→(Access2 190, 0/18) (Host3 180,eth2)→(VM6 155, VNIC6)

If any one of the paths is up and running, the link between VNF-2 and VNF-4 will be healthy and connected.

If a request is sent to the VNF link paths locator with two endpoints, such as (VNF-2, VNF-4) in this example, the VNF link paths locator will reply with the result of the above four paths in a regular expression format, which is shown below:

(VM3, VNIC3) and (<host1IP>, eth1) and (<Access1IP>, 0/22) and (<Aggregate1IP>, 0/8) and (<Aggregate1IP>, 0/6) and (<Access2IP>, 0/18) and (<Host3IP>, eth2) and (VM6, VNIC6) or (VM3,VNIC3) and (<host1IP>,eth1) and (<Access1IP>, 0/22) and (<Aggregate2IP>, 0/8) and (<Aggregate2IP>,0/6) and (<Access2IP>,0/18) and (<Host3IP>,eth2) and (VM6, VNIC6) or (VM3, VNIC3) and (<host1IP>, eth2) and (<Access2IP>,0/18) and (<Host3IP>,eth2) and (VM6, VNIC6) or (VM3,VNIC3) and (<host1IP>, eth2) and (<Access1IP>,0/22) and (<Host3IP>, eth1) and (VM6, VNIC6)

An advantage of using a regular expression to represent the VNF link paths is that the NFV Monitor can take this regular expression, fill it out with the health status of each entity, such as the VNIC (VM3, VNIC3), or host NIC (<Host3IP>, eth2), or switchport (<Access1IP>, 0/22), and then feed it into a regular expression evaluation engine to calculate a boolean result from the expression. The result would be either ‘healthy (up)’ or ‘down’, which is the end result of the VNF link status between VNF-2 115 and VNF-4 125.

More specifically, when the regular expression engine evaluates the expression for example, the regular expression shown above, it follows the mathematical rule of the priority of operators. The ‘and’ operator will have higher priority than the ‘or’ operator. Therefore, the sub-clauses concatenated using ‘or’ in the expression can be evaluated separately. Each of the sub-clauses represent one valid path between the two VNFs. For each sub-clause, only all of the entities including VNICs, PNICs, Hosts, and switch ports are ‘UP’, the value of the sub-clause will be ‘UP’. If any of them is down, the value of the sub-clause is ‘DOWN’. Since the sub-clauses are concatenated with operator ‘or’, as long as one of the sub-clause has the value of ‘UP’, the entire expression will be ‘UP’. Only when all of the sub-clauses have the value ‘DOWN’, the entire expression will have the result ‘DOWN’. The regular expression evaluation process reflects the fact that when one of the paths between the two VNFs is good, the connectivity between these two VNFs is healthy.

The following list shows the definition of an end-to-end VNF link path regular expression.

(\(VM_ID, VNIC_ID\))^{?}(and \(hostIP, PNIC\))^{?}(and \(network_appliance_IP, portID\))⁺ (and \(hostIP, PNIC\))^{?}(and \(VM_ID, VNIC_ID\))^{?}(or (\(VM_ID,VNIC_ID\))^{?}(and \(hostIP, PNIC\))^{?}(and \(network_appliance_IP, portID\))⁺ and (\(hostIP, PNIC\))^{?} and (\(VM_ID, VNIC_ID\))^{?})*

A VNF link path starts from the virtual NIC of the VM associated with one of the VNFs and ends with the virtual NIC of the VM associated with the other VNF in the input. If there are multiple VMs that construct multiple virtual links between the two VNFs, multiple regular expressions as above will be included in the output of the VNF Link Paths Locator.

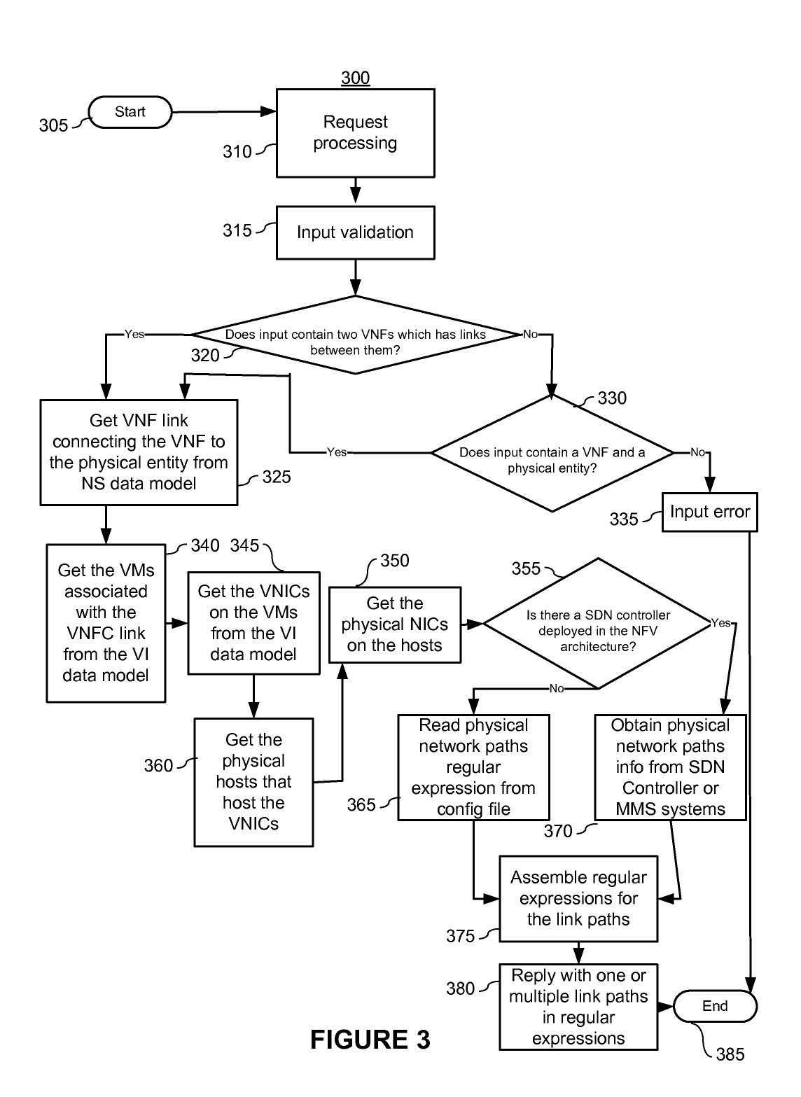

FIG. 3 shows a flowchart for the process flow to locate the network paths for two endpoints in NFV systems.

In FIG. 3, a network service (NS) data model is used. One network service contains a series of VNFs and optionally PNFs with links among them. VNFs consist of one or multiple VNF Components (VNFCs) that map to VMs in Virtualized Infrastructure (VI) data model. VI data model contains the VNFC links that connect two VNICs of the two VMs. VI data model also contains information of the physical hosts that hold the VNICs of the virtual instances. Therefore, if the request contains two VNFs as the input, embodiments of the present invention can first obtain the VNFC Link that connects the two VNFs together. Then embodiments can obtain the two VMs associated with the VNFC Link. After that embodiments can look up the VNICs associated with the VNFC link from the VI data model. Finally, embodiments get the host associated with those VNICs as well as the PNICs on the hosts that are used for the data traffic.

FIG. 3 shows a high level process flow for locating the network paths 300 including a start of the process 305. FIG. 3 also shows a request processing 310 and input validation 315. FIG. 3 shows a decision based on whether the input contains two VNFs which have links between them 320. If the input does not contain two VNF's with links between them then the decision is based on whether the input contains a VNF and a physical entity 330. If not, then there is an input error 335 and the process ends 385. If the input does contain VNF and a physical entity or if the input contains two VNFs with a link between them, then get the link connecting the VNF to the physical entity from the NS data model 325. Also, get the VMs associated with the VNFC link from the VI model 340, get the VNICs on the VMs from the VI data model 345, get the physical hosts that host the VNICs 360, and get the physical NICs on the hosts 350. The process also determines if there is an SDN controller deployed in the NFV architecture 355. If there is an SDN deployed, then obtain physical network paths information from the SDN controller or MMS systems 370. If there is not an SDN controller deployed, then read physical network paths regular expression from the config file 365. Assemble regular expressions for the link paths 375 and reply with one or more link paths in regular expression 380. Then end the process 385.

As described above, NFV systems with network services provided by a service chain can run on top of a network environment with or without SDN Controller. In the embodiment when SDN Controller is not available in an NFV system, embodiments of the present invention can obtain the physical paths in the physical network topology through a configuration file; in the case when an SDN Controller is deployed in an NFV system, embodiments of the present invention can send a request to the SDN controller dynamically at run time to obtain the physical paths that connect the two physical NICs together.

In a configuration file, embodiments of the present invention can define the physical paths associated with two physical host NICs as two endpoints. The following is the definition of the regular expression for the specification of the physical paths info in the configuration file:

\[[hostIP|\(network_appliance_IP, portID\)], [hostIP|\(network_appliance_IP, PortID\)]\]=

\(hostIP, PNIC\)(and \(network_appliance_IP, portID\))⁺ and \(hostIP, PNIC\)(or \(hostIP, PNIC\)\(and \(network_appliance_IP, portID\))⁺ and \(hostIP, PNIC\))*

An example regular expression that specifies the physical paths would look like the following:

[host1IP, host3IP]=(<host1IP>, eth1) and (<Access1IP>, 0/22) and (<Aggregate1IP>, 0/8) and (<Aggregate1IP>, 0/6) and (<Access2IP>, 0/18) and (<Host3IP>, eth2) or (<host1IP>,eth1) and (<Access1IP>, 0/22) and (<Aggregate2IP>, 0/8) and (<Aggregate2IP>,0/6) and (<Access2IP>,0/18) and (<Host3IP>,eth2) or (<host1IP>, eth2) and (<Access2IP>,0/18) and (<Host3IP>,eth2) or (<host1IP>, eth2) and (<Access1IP>,0/22) and (<Host3IP>, eth1)

The expression captures the multiple physical paths between two physical NICs on two hosts in NFV system.

When the VNF link paths locator is initialized during NFV Monitor initialization, the VNF link paths locator can read the configuration file and load the regular expression into the memory. At runtime, if there is any change of physical network topology that would change the paths between any two hosts in the NFV system, the system administrator will modify the configuration file with the latest physical paths information. The VNF link paths locator can periodically monitor the configuration file to load the latest info.

With the physical paths information in the configuration file in regular expression formation, the VNF link paths locator will be able to generate end-to-end paths between two VNFs at any time upon receiving requests.

One embodiment uses a configuration file for the user to input the multiple paths between two host NICs in regular expression format. In another embodiment, a deployment embodiment, when there is an SDN Controller in the system that has the knowledge/information regarding the physical network topology, the manual input of the multiple paths between two host NICs can be used.

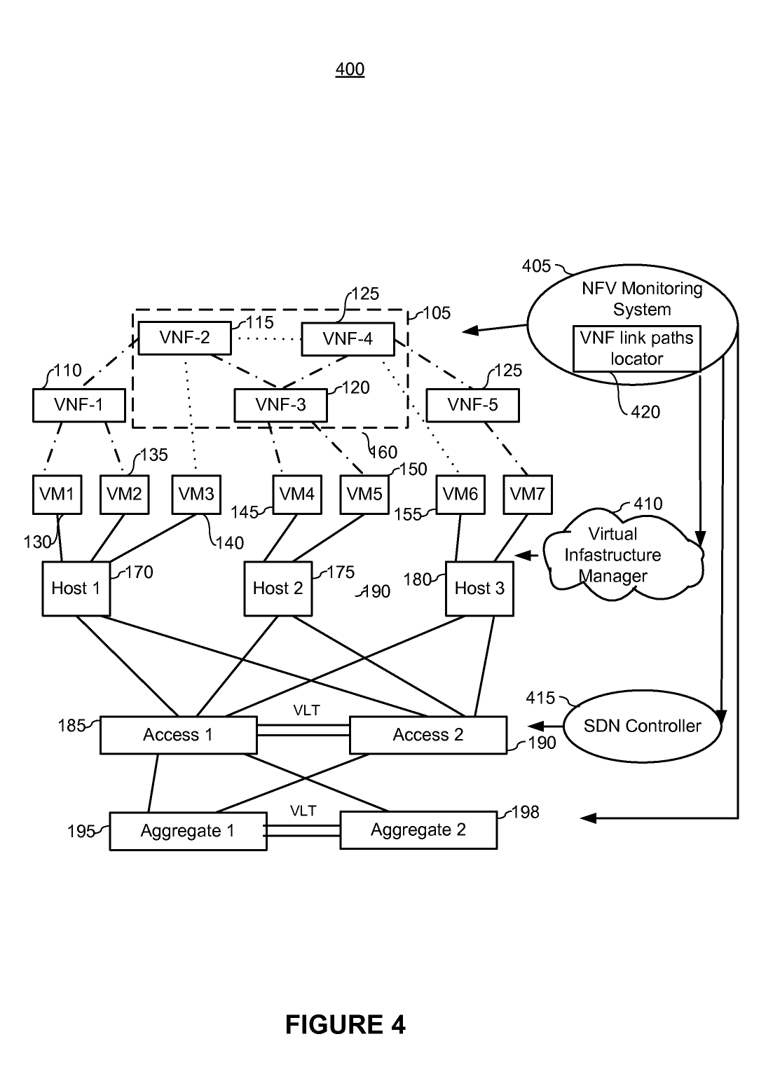

FIG. 4 shows a block diagram showing how an NFV Monitoring System 405 interacts with SDN controller 415 to obtain the physical network paths information at runtime according to embodiments of the present invention.

In the deployment embodiment, shown in FIG. 4, when there is an SDN controller 415 deployed in the NFV system, the SDN controller 415 has the knowledge of the network topology including the multiple paths between two physical host NICs. The SDN controller 415 can also maintain the network topology information in their data models for dynamic changes in the physical network topology. At the same time, the systems provides north bound application programming interfaces (APIs) to expose these information from the systems. In these cases, NFV Monitoring System 405 can send a request to SDN controller 415 to obtain multiple paths information at runtime.

More specifically, during initialization of the NFV Monitoring System 405, the VNF link paths locator 420 can send a request to the SDN controller 415 to obtain the multiple paths information between any two physical host NICs in the NFV system 400. At runtime, whenever there is a physical network topology change, the SDN controller 415 can send an event notification to the VNF link paths locator 420. Upon receiving the notification, VNF link paths locator 420 can make another call to the SDN controller 415 asking for the updated physical paths info between any two hosts in the NFV system. The physical paths information would be:

Path1: (Host1, eth1)→(Access1, 0/22)→(Aggregate1, 0/8)→(Aggregate1, 0/6)→(Access2,0/18) (Host3, eth2))

Path2: (Host1,eth1)→(Access1, 0/22)→(Aggregate2,0/6) (Aggregate2, 0/6)→(Access2,0/18)→(Host3,eth2)

Path3: (Host1,eth1)→(Access1, 0/22)→(Access1,0/18)→(Host3,eth1)

Path4: (Host1,eth2)→(Access2, 0/22)→(Access2,0/18) (Host3,eth2)

The VNF link paths locator can generate the regular expression based on the above result. With this regular expression, VNF link paths locator could generate end-to-end link paths between any VNFs at any time when there is a request to this component asking for such information.

The output expression from the VNF link paths locator 420 can be used at the NFV monitoring system 405 for monitoring and analytics purposes.

More specifically, the output could be used in the following perspectives of an NFV monitoring system:

Using the expression, the system can evaluate the health status of the VNF link object between two VNF instances, the VNF to PNF links, or PNF to VNF links.

In the visualization of the VNF Forwarding Graph, when the user drills down into a VNF link, VNF to PNF links, or PNF to VNF links, multiple paths can be presented.

A similar approach can be used in other health status evaluation embodiments involving multiple underlying paths, such as redundant virtual and physical infrastructure to support application servers.

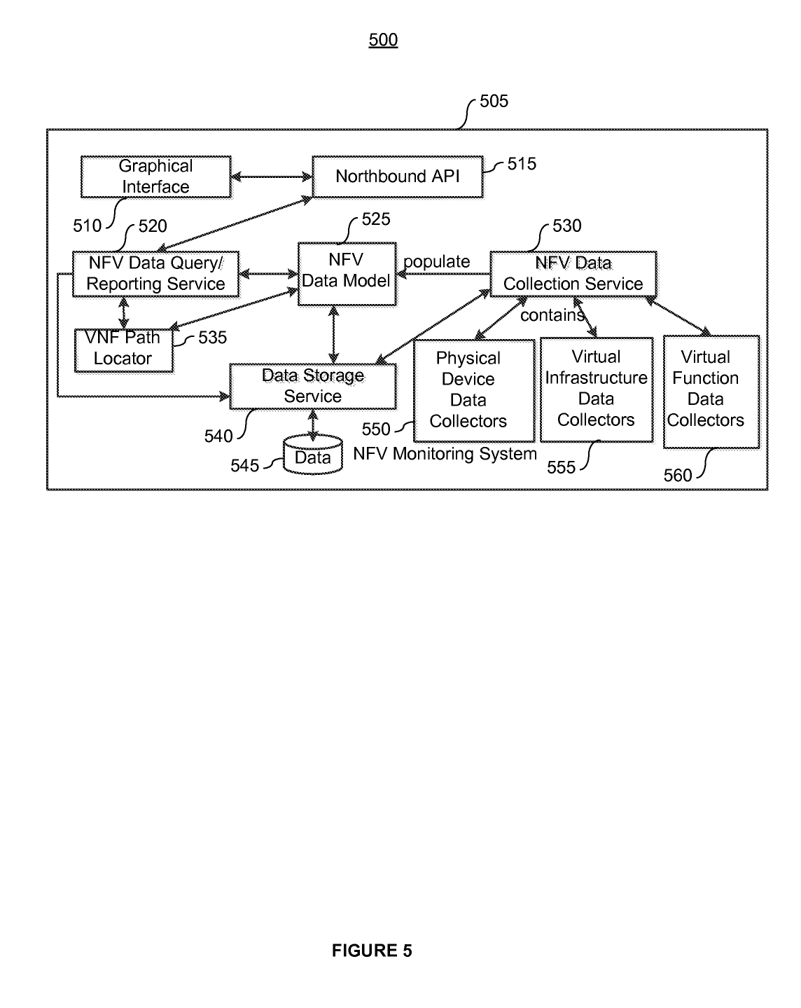

FIG. 5 depicts a block diagram of an NFV monitoring system according to embodiments of the present invention. FIG. 5 shows NFV monitoring system 505 including graphical interface 510, northbound API 515, NFV data query/reporting service 520, NFV data model 525, NFV data collection service 530, VNF path locator 535, data storage service 540, physical device data collectors 550, virtual infrastructure data collectors 555, virtual function data collectors 560, and data 545. In embodiments of the present invention, physical device data collectors 550, virtual infrastructure data collectors 555, virtual function data collectors 560 collect data used by NFV data collection service 530. NFV data collection service 530 can be used to populate NFV data model 525. Physical device data collectors 550 can collect data from physical devices. Virtual infrastructure data collectors 555 can collect data from virtual infrastructure. Virtual function data collectors 560 can collect data from virtual functions.

NFV data model 525 can contain data models for the physical hardware, the virtualized infrastructure, and the virtual network functions layers. NFV data query/reporting service 520 can retrieve data from NFV data model 525 to satisfy user queries and construct user defined reports related to the status of the network functions. For reporting the health status of the links between two virtual functions or one virtual function and one physical function, the NFV data query/reporting service 520 can communicate with VNF path locator 535 to achieve the purpose. Graphical interface 510 can communicate with NFV monitor northbound API 515 to visualize the status of the network functions. Upon receiving requests from the graphical interface 510, the northbound API 515 can delegate the requests to NFV data query/reporting service 520 to fulfill the user requests from the graphical interface 510. One advantage of the present invention is that it provides a component that is capable of reporting multiple virtual and physical network paths associated with a VNF link in a VNF service chaining scenario.

Another advantage of the present invention is that the VNF link paths locator described in the disclosure outputs a regular expression that can be used by the NFV Monitor to evaluate the status of the paths reported by the VNF link paths locator by feeding it to a regular expression evaluation engine.

Yet another advantage of the present invention is that it addresses the problem in NFV monitoring area to report the network service health status based on the evaluation of the VNF links that depend on multiple network paths in virtual and physical network layers of NFV architecture.

Yet another advantage of the present invention is that it fits into the scenario when NFV monitoring system does not have the capability to discover the underlying physical network topology of NFV systems.

One of ordinary skill in the art will appreciate that various benefits are available as a result of the present invention.

It shall be noted that aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

While the inventions have been described in conjunction with several specific embodiments, it is evident to those skilled in the art that many further alternatives, modifications, application, and variations will be apparent in light of the foregoing description. Thus, the inventions described herein are intended to embrace all such alternatives, modifications, applications and variations as may fall within the spirit and scope of the appended claims.

What is claimed is:

1. A network functions virtualization system, comprising:
a plurality of virtualized network functions connected to each other in a chain;
a virtualized network functions link used to connect each of the plurality of virtualized network functions
a virtual layer associated with at least one virtualized network function;
a physical layer associated with the virtual layer; and
a paths locator configured to monitor the virtualized network functions link including a health status of at least one path in the physical layer and the virtual layer.

2. The network functions virtualization system of claim 1 wherein the physical layer comprises a host computer.

3. The network functions virtualization system of claim 1 wherein the physical layer comprises a network interface controller.

4. The network functions virtualization system of claim 1 wherein the virtual layer comprises a virtual machine.

5. The network functions virtualization system of claim 1 wherein the virtual layer comprises a virtual network interface controller.

6. The network functions virtualization system of claim 1 further comprising a software defined networking controller.

7. The network functions virtualization system of claim 6 wherein the paths locator is configured to operate in conjunction with the software defined networking controller.

8. The network functions virtualization system of claim 1 wherein the paths locator is configured to output a path in a regular expressions format.

9. A method for locating paths in a network functions virtualization network system, comprising:
sending a request to determine a path between a first and a second virtualized network functions that are linked to each other;
determining the link connecting the virtualized network functions to a physical entity from a network service model;
determining a virtual machine associated with the link;
determining a virtual network interface controller on the virtual machine from a virtual interface network model;
determining a physical host that hosts the virtual network interface controller;
determining a physical network interface controller on the host;
determining a physical network path; and
replying with at least one link path.

10. The method of claim 9 further comprising determining whether there is a software defined networking controller implemented.

11. The method of claim 10 further comprising reading a physical network paths regular expression from a configuration file.

12. The method of claim 9 further comprising obtaining a physical network paths information from a software defined networking controller.

13. The method of claim 9 further comprising assembling a regular expressions for the link paths.

14. The method of claim 12 wherein the replying with the link path is in a regular expression format.

15. A network functions virtualization monitoring system, comprising:
a network functions virtualization data collection service further comprising:
a physical device data collector enabling data collection from a physical device;
a virtual infrastructure data collector enabling data collection from a virtual infrastructure;
a virtual function data collector enabling data collection from a virtual function; and
a paths locator used to monitor a health status of at least one path in the network functions virtualization architecture.

16. The system of claim 15 further comprising a network functions virtualization data model.

17. The system of claim 16 wherein the paths locator is configured to output a path in a regular expression format.

18. The system of claim 15 further comprising a network functions virtualization data query/reporting service enabled to leverage at least one of the network functions virtualization data model and the paths locator to report the health status of the at least one path in the network functions virtualization architecture.

19. The system of claim 17 further comprising a regular expression engine configured to evaluate a status of a path.

20. The system of claim 15 wherein the virtual layer comprises a virtual network interface controller.
